(19) United States
(12) Patent Application Publication
(10) Pub. No.: US 2026/0228779 A1
(43) Pub. Date: Aug. 6, 2026

(54) MANAGING ROOM-BASED HOTEL COMMUNICATION TERMINAL CONTENT BASED ON GUEST INFORMATION

(71) Applicant: The Hotel Communication Network, Inc., Ottawa (CA)

(72) Inventors: Kevin Bidner, Ottawa (CA); James M. Behmke, Boston, MA (US)

(21) Appl. No.: 19/634,534

(22) Filed: Mar. 31, 2026

Related U.S. Application Data
(63) Continuation of application No. 17/442,965, filed on Mar. 26, 2020, now abandoned.
(60) Provisional application No. 62/823,801, filed on Mar. 26, 2019.

(51) Int. Cl. G06Q 30/0251; G06Q 30/0207; G06Q 30/0226; G06Q 50/12

(52) U.S. Cl. CPC G06Q 30/0271; G06Q 30/0226; G06Q 30/0239; G06Q 50/12

(57) ABSTRACT

The techniques herein are directed generally to managing room-based hotel communication terminal content based on guest information. In one embodiment, a server receives registration information when a guest checks into a hotel including an identification of the guest and a particular assigned room, and then identifies a particular communication terminal that is associated therewith. Either the server or the particular communication terminal then queries a guest information database using the identification of the guest to determine a particular grouping associated with the guest, resulting in an interactive interface comprising customized content specific to the particular grouping associated with the guest. The particular communication terminal presents the interactive interface comprising customized content specific to the particular grouping associated with the guest on a corresponding GUI of the particular communication terminal.

### RELATED APPLICATIONS

This application is continuation of U.S. Patent Application No.: 17/442,965, filed September 24, 2021, entitled MANAGING ROOM-BASED HOTEL COMMUNICATION TERMINAL CONTENT BASED ON GUEST INFORMATION, by Kevin Bidner, et al.,, which is a U.S. National Stage Application of PCT/IB2020/000269, filed March 26, 2020, entitled MANAGING ROOM-BASED HOTEL COMMUNICATION TERMINAL CONTENT BASED ON GUEST INFORMATION, by Kevin Bidner, et al., which claims priority to U.S. Provisional Application No. 62/823,801, filed on March 26, 2019, entitled SYSTEM AND METHOD TO ENABLE HOTEL ROOM BLOCK REFERENCE FOR MULTIPLE CUSTOMER LOYALTY TIERS, by Kevin Bidner, the contents of which being incorporated herein by reference in their entirety.

### TECHNICAL FIELD

The present disclosure relates generally to hotel communication systems, and, more particularly, to managing room-based hotel communication terminal content based on guest information.

### BACKGROUND

Typical channels available for a hotel to convey information to its guests, particularly while staying at the hotel, include mass-distributed information, such as printed books or brochures, websites, and one-way television broadcasts to all guest rooms, or else individually focused information, such as printed letters, emails, or text messaging. Mass-distributed information can be helpful when it applies to all or a broad range of the hotel’s guests, but individually focused information is often needed for particular personal instances, or else to better tailor the hotel experience to various groups or types of guests. However, individually focused information is often difficult to convey, especially in a timely manner, without burdening limited hotel resources, or else without relying too greatly on guests’ technical ability or attention to things like emails or text messages from unknown numbers, assuming the guests even travel with their smart communication devices.

### SUMMARY

The techniques herein are directed generally to managing room-based hotel communication terminal content based on guest information. In particular, hotels, and particularly those with a loyalty rewards program and associated partner businesses, can use the techniques herein to provide real-time, on-demand, customized content to their guests, directly to their hotel rooms, in order to optimize customer response. That is, a method and system are described herein for distributing targeted, on-demand content to hotel guests may be implemented in one or more hotels by providing communication terminal in hotel guest rooms, where such devices may communicate with a server and software system to provide on-demand access to both static and changing content, including formatting and information. For example, content may be customized based on the guest's standing in the hotel's customer loyalty program, on the guest's interests as indicated in third-party databases, on other groupings such as events the guest is attending, and so on.

In one embodiment, a system herein comprises: a server; and a plurality of communication terminals in communication with the server, each of the communication terminals having a graphical user interface (GUI) and being associated with a respective room of a plurality of hotel rooms of a hotel; wherein the server is configured to receive registration information when a guest checks into the hotel, the registration information including an identification of the guest and a particular assigned room of the plurality of hotel rooms; wherein the server is configured to identify a particular communication terminal of the plurality of communication terminals that is associated with the particular assigned room; wherein one of either the server or the particular communication terminal is configured to query a guest information database using the identification of the guest to determine a particular grouping associated with the guest; wherein one of either the server or the particular communication terminal is configured to store an interactive interface comprising customized content specific to the particular grouping associated with the guest; and wherein the particular communication terminal is configured to present the interactive interface comprising customized content specific to the particular grouping associated with the guest on a corresponding GUI of the particular communication terminal.

In another embodiment, a method herein comprises: receiving, at a server, registration information when a guest checks into a hotel, the registration information including an identification of the guest and a particular assigned room of a plurality of hotel rooms of the hotel; identifying, by the server, a particular communication terminal of a plurality of communication terminals in communication with the server that is associated with the particular assigned room, wherein each of the communication terminals has a graphical user interface (GUI) and is associated with a respective room of the plurality of hotel rooms of the hotel; querying, by the server, a guest information database using the identification of the guest to determine a particular grouping associated with the guest; generating, by the server, an interactive interface comprising customized content specific to the particular grouping associated with the guest; and causing, by the server, the particular communication terminal to present the interactive interface comprising customized content specific to the particular grouping associated with the guest on a corresponding GUI of the particular communication terminal.

In still another embodiment, a method herein comprises: receiving, at a particular communication terminal of a plurality of communication terminals, identification of a guest, wherein the particular communication terminal is associated with a particular room of a plurality of hotel rooms of a hotel, and wherein the guest has checked into the hotel and has been assigned to the particular room; querying, by the particular communication terminal, a guest information database using the identification of the guest to determine a particular grouping associated with the guest; storing, by the particular communication terminal, an interactive interface comprising customized content specific to the particular grouping associated with the guest; and presenting, on a corresponding graphical user interface (GUI) of the particular communication terminal, the interactive interface comprising customized content specific to the particular grouping associated with the guest.

Other embodiments of the present disclosure may be discussed in the detailed description below, and the summary above is not meant to be limiting to the scope of the invention herein.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example system in accordance with one embodiment;

FIG. 2 illustrates an example system in accordance with one embodiment;

FIG. 3 illustrates an example method in accordance with one embodiment;

FIG. 4 illustrates an example system in accordance with one embodiment;

FIG. 5 illustrates an example system in accordance with one embodiment;

FIGS. 6A-6B illustrate an example interactive interface in accordance with one embodiment;

FIG. 7 illustrates an example system in accordance with one embodiment;

FIG. 8 illustrates another example interactive interface in accordance with one embodiment;

FIG. 9 illustrates an example simplified procedure for managing room-based hotel communication terminal content based on guest information in accordance with one or more embodiments described herein, particularly from the perspective of a hotel server; and

FIG. 10 illustrates another example simplified procedure for managing room-based hotel communication terminal content based on guest information in accordance with one or more embodiments described herein, particularly from the perspective of a communication terminal.

### DESCRIPTION OF EXAMPLE EMBODIMENTS

As noted above, typical channels available for a hotel to convey information to its guests generally include mass-distributed information and individually focused information. Mass-distributed information typically is best when it applies to all or a broad range of the hotel’s guests, while individually focused information is needed for personally directed communications or group-based communications for particular groups or types of guests.

As also noted above, however, individually focused information is often difficult to convey, especially in a timely manner, without burdening limited hotel resources. In particular, printing individual or even group-based letters can be a time consuming and difficult task. Alternative techniques used by hotels today to relay individually focused information are often directed to tech-savvy guests that carry their own smart devices with them at all times.

As an illustrative example, many hotels participate in some sort of loyalty rewards program. Loyalty rewards programs may be specific to a single hotel, may be implemented across a chain of hotels, or may extend to a group of partnered businesses. Typically, members who occasionally stay (or fly, or purchase, etc.) with a business involved in the program will qualify for rewards at a basic loyalty tier (e.g., gold level membership). Members who frequently patronize involved businesses, or who pay for an upgraded membership, will qualify for rewards at a higher loyalty tier (e.g., platinum level membership).

Hotels will often partner with other businesses in the program, or with geographically local businesses, to offer rewards in the form of discounts, upgraded access or services, etc., to the mutual benefit of both partners. However, when a guest with loyalty rewards membership checks into a hotel, it may be expensive, time intensive, and logistically difficult to inform them of rewards they may be eligible for and particularly interested in. For instance, as noted above, typical channels available for this information include physical, printed matter, one-way television broadcast to all guest rooms, or online offers sent via email or listed on a loyalty rewards program website.

Printed matter may be delivered to the guest's assigned room or may be available at the concierge desk. Some rewards may be time-sensitive, however. Having to print, store, and distribute printed matter to advertise these rewards may be impractical.

Also, many rewards will differ across loyalty tier levels and will not apply to hotel guests who are not members. A one-size-fits-all television broadcast could lead to misunderstandings and poor guest experiences if non-members attempt to take advantage of a reward they are not eligible for.

Furthermore, not all guests will travel with a device with which to view email or login to a loyalty rewards program website. Many guests who are loyalty rewards program members may not be familiar with using program's website, or the website may not offer adequate search and filtering mechanisms. This makes website or email notification an unreliable tool to advertise rewards a guest might take advantage of on the spur of the moment.

The techniques herein, therefore, provide a system and method for managing room-based hotel communication terminal content based on guest information. In particular, hotels, and particularly those with a loyalty rewards program and associated partner businesses, can use the techniques herein to provide real-time, on-demand, customized content to their guests, directly to their hotel rooms, in order to optimize customer response.

Notably, "LAN" refers to a local area network, which is a computer network that interconnects computers within a limited area, such as a residence, a business, or an office building. Also, "PMS" refers to a property management system, which is a platform that enables a hotel or group of hotels to manage front-office capabilities, such as booking reservations, guest check-in/check-out, room assignment, managing room rates, billing, food and beverage operations, housekeeping and maintenance management, sales and catering, and revenue management.

One medium a hotel may use to deliver on-demand, customized content to hotel guests is a hotel-wide communications network based on placing communication terminals in every hotel room. These communication terminal may be a tablet computing device owned, rented, leased or licensed by the hotel, dedicated to an assigned room and configured with applications specific to guest interaction, as well as basic tablet computing functionality such as a touch screen, speakers and microphones, and network connectivity. Communication terminals may be off-the-shelf tablet computers, custom communications consoles, touch-screen televisions with wireless connectivity, or even systems similar to smart home controllers where a small computing module allows a guest to control audiovisual and other connected devices in their assigned room (e.g., speakers and televisions, lights, curtains, etc.) via the interface and/or voice recognition, optionally with various additional machine learning / artificial intelligence capabilities.

To send customized content to specific communication terminals, a hotel may install a centralized control system for all communication terminals, in the form of a hotel server. The hotel server may be a dedicated server, programmed specifically for the task of determining information for a specific guest (e.g., loyalty tier, etc.) and providing appropriate configuration commands to the communication terminals. The hotel server may receive inputs from existing data repositories, such as a PMS, member profile databases, a loyalty rewards program database, other databases available over the Internet, and digital libraries of existing content. Based on inputs received, the hotel server may configure communication terminals throughout the hotel to load and display on-demand the content specifically targeted toward a guest accessing the communication terminal in their assigned room.

In one specific embodiment, based on inputs received, the hotel server may configure communication terminals throughout the hotel to boot up from specific memory blocks within a boot directory located within each communication terminal. The boot directory may contain all of the content specific to a hotel, divided into boot blocks associated with appropriate selection criteria. In this manner, boot code in the different sections of the boot directory may configure the communication terminals to load and display on-demand the content specifically targeted toward a guest accessing the communication terminal in their assigned room. In an embodiment, the communication terminals boot up and acquire content from the hotel server, content management system, or third party systems over the Internet.

This disclosure relates to a method and system that implement the solution described above. One of skill in the art will realize that the methods and systems of this disclosure describe proscribed functionality associated with a specific, structured communications network interface, wherein a specially programmed server is configured to manage dedicated communication terminals. Specifically, the methods and systems, among other things, are directed to identify and distribute customized, on-demand content to guests of a hotel, particularly by managing room-based hotel communication terminal content based on guest information. One of skill in the art will realize that these methods are significantly more than abstract data collection and manipulation.

Further, the methods provide a technological solution to a technological problem, and do not merely state the outcome or results of the solution. As an example, one technological hurdle to providing customized, on-demand content is the disparity of input sources the control software must interpret and act upon, and the variety of devices the hotel may employ as communication terminals. The hotel server described in this solution must be more than a simple router.

To truly improve upon manual dissemination of content to room-based hotel communication terminals based on guest information, the hotel server determines programmatically which content applies to each guest through a minimal amount of category tagging. Input sources such as loyalty rewards program databases may be queried and some form of tagging or other parameter generated to indicate which devices must be configured and how, such as through real-time configuration or else by booting from particular portions of their boot directories. The hotel server and communication terminal software that provides the solution disclosed herein is specifically designed to address these technical challenges.

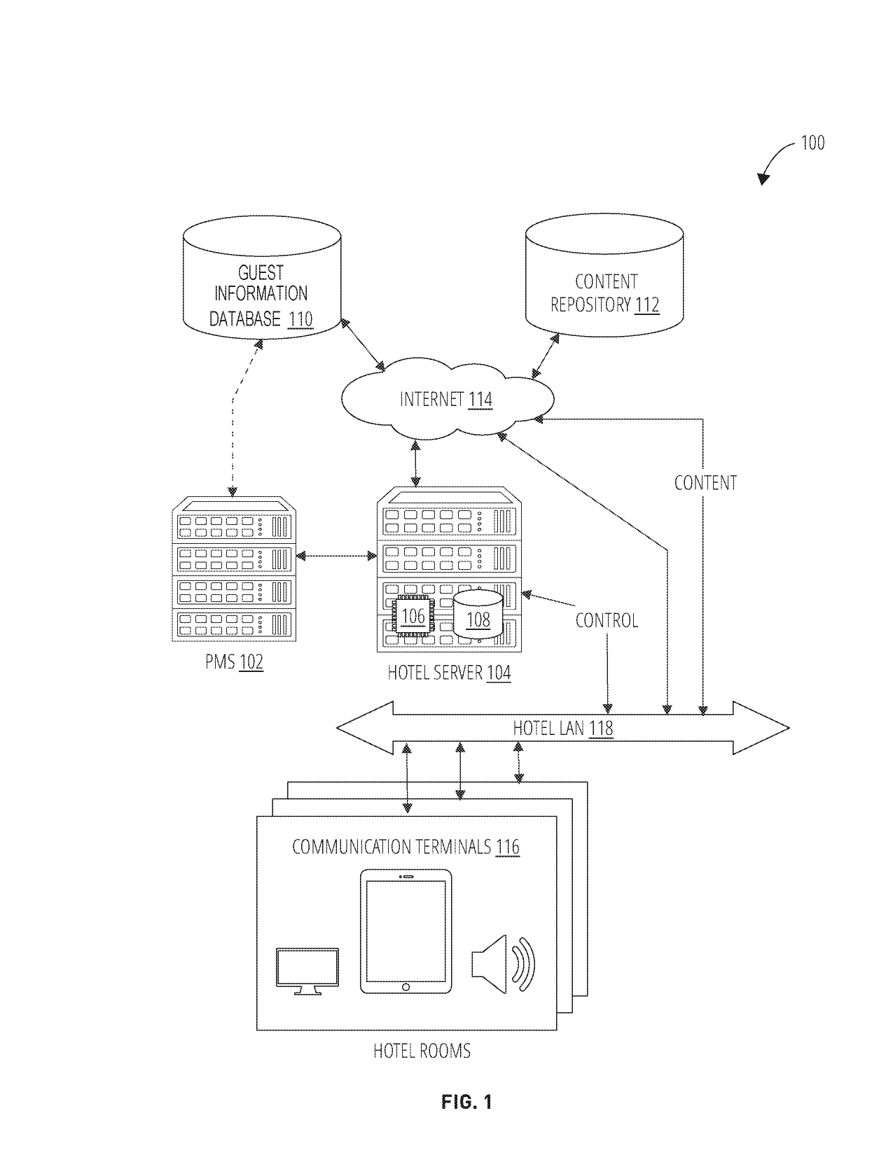

Referring to FIG. 1, the system 100 in one embodiment comprises a PMS 102, a hotel server 104, a guest information database 110 (e.g., a loyalty rewards program database, a guest profile database, etc.), a content repository 112, and communication terminals 116 located in each hotel room.

The PMS 102 may be the administration and accounting system used by the hotel to identify guests, assign rooms at check-in, and store a record of a guest's registration information. The PMS 102 may be a server or database that resides within the hotel or at a remote location. The PMS 102 may have a wired or wireless communications connection to the hotel server 104. Through the communications connection, the PMS 102 may notify the hotel server 104 that a guest has been registered, and transmit pertinent registration information, such as the guest's name assigned room.

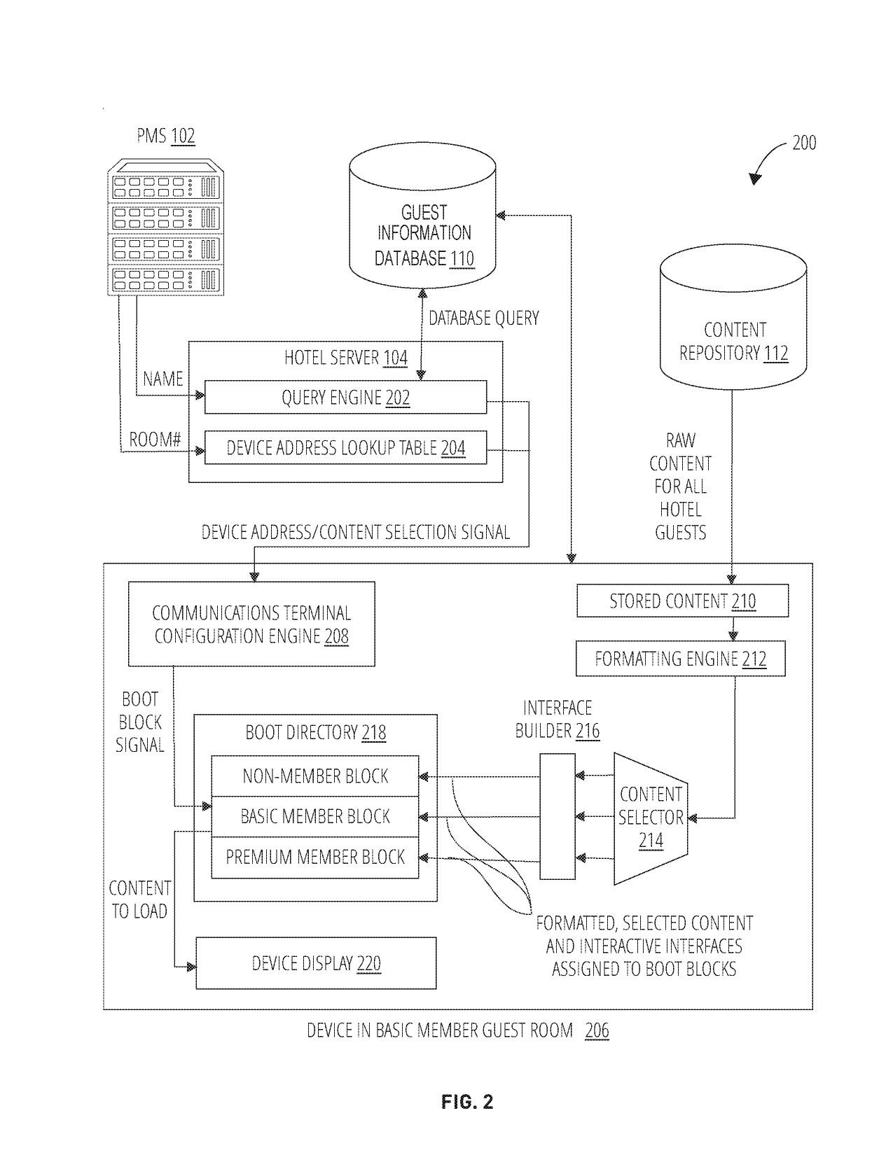

The hotel server 104 manages the configuration of communication terminals 116 to load customized loyalty content. The hotel server 104 may have processor 106 and memory 108 components capable of executing the steps of the method disclosed herein. The hotel server 104 may be cloud based or on the hotel property. The hotel server 104 may have a wired or wireless connection to the Internet 114, allowing communication with a guest information database 110. The hotel server 104 may connect to the communication terminals 116 through a hotel LAN 118, or if the hotel server 104 is remotely located, through the Internet 114. The hotel server 104 may configure the communication terminals 116 to provide on-demand, customized content based on the guest information (e.g., loyalty tier level, personal information, other groupings of guests, and so on) of each individual guest. The mechanisms that accomplish this are shown in greater detail in FIG. 2.

The guest information database 110 comprises one or more data stores for guest information, such as personal information (e.g., name, address, demographics, etc.), hotel loyalty databases (e.g., hotel rewards profiles and/or points, etc.), or other groupings of guests (e.g., conference attendee information, wedding guests, other events, and so on). The database(s) 110 may be public or private databases residing at the hotel or at a remote location. In some embodiments, one or more of the databases 110 may also be integrated with the PMS 102, allowing the hotel to send guest information directly to the hotel server 104, with no database query needed.

For an example, in one embodiment, one particular type of database 110 is a loyalty rewards program database that may store information pertaining to guests who hold membership in the hotel's customer loyalty program. Customer loyalty information may comprise the guest's name and contact information, a customer loyalty program ID number, and categorization within one or more loyalty tiers (e.g., gold membership or platinum membership). Customer loyalty information may also include details about the guest's history with the hotel, hotel chain, and any other participating partners. For example, a loyalty rewards program database may store a record of nights stayed at the hotel, miles traveled on a partnered airline, or money spent on a loyalty credit card, and the rewards thereby earned.

The content repository 112 may store a body of media curated by a hotel administrator, by various advertisers, various group/event organizers, or by a third-party content specialist. The stored content may be tagged for applicability to different guests based on their inclusion within one or more identified groups, such as whether they are participating in a particular event, belong to a particular group, or have a particular loyalty tier level, and so on. The content repository 112 may be databases or libraries available online, a dedicated media storage server networked directly to the hotel server 104, or a partition or folder structure within hotel server 104 memory. The content repository 112 may also be a plurality of these sources, in any combination.

In some embodiments, the content repository 112 may reside within a content management system (CMS), located on a centrally located server, and accessible to hotel administration. The CMS may implement a graphical user interface (GUI) allowing content to be uploaded, edited, categorized (tagged), formatted using stored templates, routed for approval before publication, and published for access by the communication terminals 116. In such an embodiment, content curation and routing to more than one hotel's communication terminals may provide a solution scaled to multiple hotels participating in the same distribution of content, such as a distributed customer loyalty program.

The communication terminals 116 may be located in each hotel room and may incorporate real-time voice and data communications, with the capability for both unidirectional (one-way) broadcast and bidirectional (two-way) interaction with the guest. As noted above, these devices may be off-the-shelf tablet computers or custom communications consoles, or they may also be smart home-style systems.

The communication terminals 116 may receive guest-based content from the content repository 112 over an Internet 114 connection with the hotel LAN 118. Communication terminals 116 may format and store the content and generate interfaces for the content appropriate to the type of devices used. The communication terminals 116 may accept a control signal from the hotel server 104 indicating which content they may load (e.g., format and/or information displayed), such as through initiating a real-time download of the content (activating a download from, or upload to, the terminals) or else through dictating how the terminals may boot up and load the content.

The hotel LAN 118 may be a closed hotel intranet carried over wired or wireless data channels, or any other communications channel in place throughout the hotel. The hotel LAN 118 provides connection between the hotel server 104 and the communication terminals 116.

Referring to FIG. 2, the system 200 in one particular embodiment (e.g., using boot blocks to configure the communication terminals) comprises a PMS 102, a hotel server 104, a guest information database 110 (e.g., loyalty rewards program database, etc.), a content repository 112, and a communication terminal operating, in this example, as a device in “basic member” guest room, hereinafter “device 206”. The hotel server 104 may contain logic for a query engine 202 and a device address lookup table 204. The device 206 may include a communications terminal configuration engine 208, stored content 210, a formatting engine 212, a content selector 214, an interface builder 216, a boot directory 218, and a device display (and user interface) 220.

The query engine 202 in the hotel server 104 may receive a guest's name (or other identification, such as a username, account number, or group identification, etc.) from the PMS 102 upon check-in and may send a query to the guest information database 110. Results of this query may include relevant guest information such as particular groups, events, etc., or, specific to this example, the guest's loyalty tier level, loyalty rewards points accrued, and purchase history related to the loyalty rewards program.

The hotel server 104 may also receive the guest's assigned room number from the PMS 102. This assigned room number may be sent to a device address lookup table 204 that may provide addressing information needed to signal the correct device (in this case, the device 206). The device address may be an IP address assigned by the hotel LAN 118, a MAC address programmed into a network adaptor installed in the communication terminal, or some other unique address by which the device can be distinguished over the hotel LAN 118. The device address is sent over the hotel LAN 118 to configure the addressed device to boot up and configure its interactive interface as directed.

According to this boot-based embodiment, the logic for selecting and assigning a boot block address to a communication terminal may be run concurrently with another logic structure designed to populate the boot directory 218 blocks with customized content to be accessed by the device 206 in basic member guest room. A body of content may be loaded into stored content 210 on all communication terminals in a hotel from a content repository 112. The content stored therein may be created using a predetermined format compatible with templates used to construct interactive interfaces for display on the communication terminals. The content may also come from sources using a variety of formats not immediately compatible. Each file or file library stored may be categorized (tagged) for applicability to a particular guest grouping, e.g., loyalty tier level. Files may also be tagged based on their formatting attributes or origins.

Updates to content in an associated content repository 112 may be automatically pushed down to communication terminals, or the communication terminals may be programmed to periodically monitor the content repository 112 for added or modified content. Content may also be updated multiple times in a draft state or "sandbox" area and be sent to communication terminals only when it is approved and published through a content management platform. Content stored in the device 206 may be sent to a formatting engine 212. The formatting engine 212 may recognized content tagged as being already compatible with interactive interface requirements. Compatible content may be sent directly through with no modification. Files sent with no tagging or tagging that indicates a possible incompatibility may be modified by the formatting engine 212 to generate files that may be displayed and otherwise manipulated within the interactive interface.

Formatted content may pass through a content selector 214. For example, based on group-based (e.g., loyalty tier level) tagging, the content selector 214 may pass the content to the interface builder 216, along with instruction on which interface template the content may be associated with.

The interface builder 216 may generate a graphical user interface (GUI) using markup code, such as HTML or XML. The GUI may also be implemented as machine logic, such as JavaScript, that may be integrated into a browser or other web-based application installed on the communication terminals, or as a non-transitory machine logic configuration for operating a computer processor. This interface, when instantiated by the processor may comprise links, buttons, text interface, and graphics. The interactive interface may also provide instructions and functionality allowing the guest to access a Web page or complete a simple form in order to access certain features of the content, such as, for example, to take advantage of an offered (e.g., loyalty-based) reward.

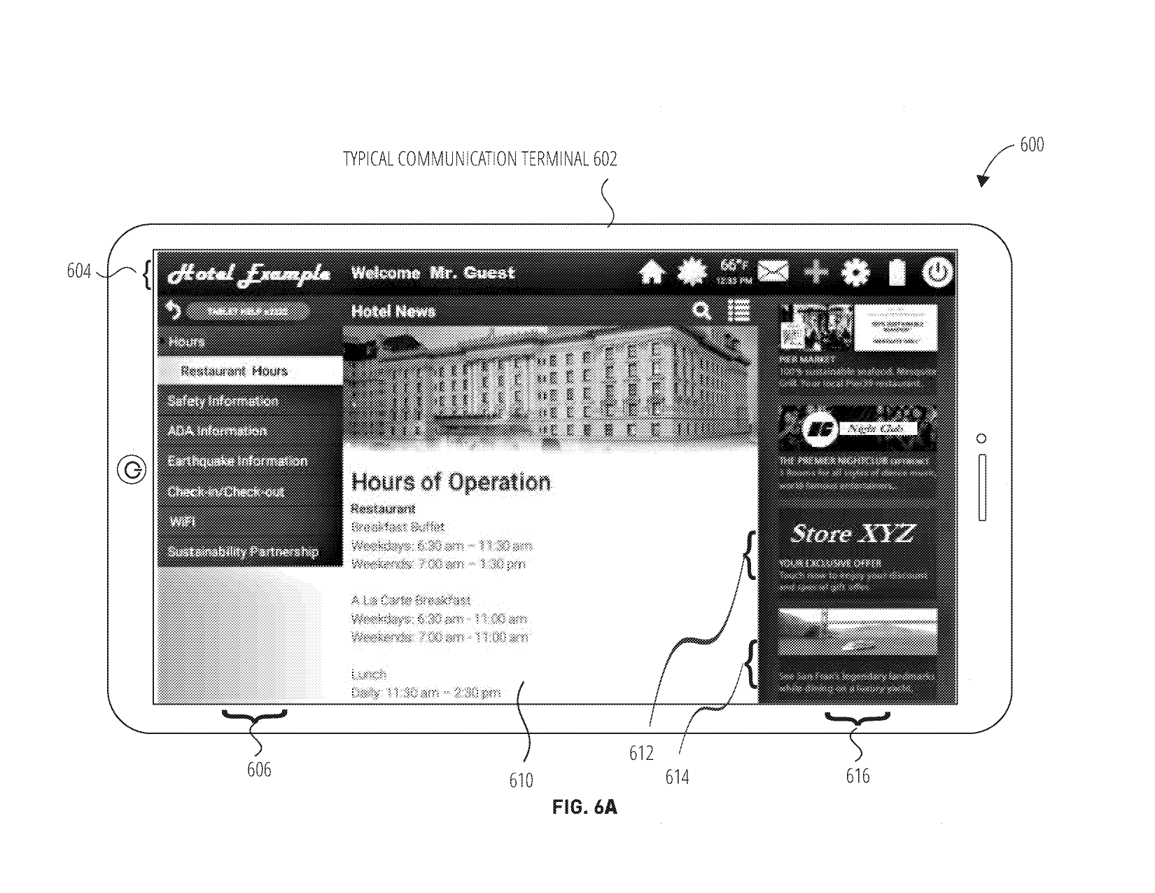

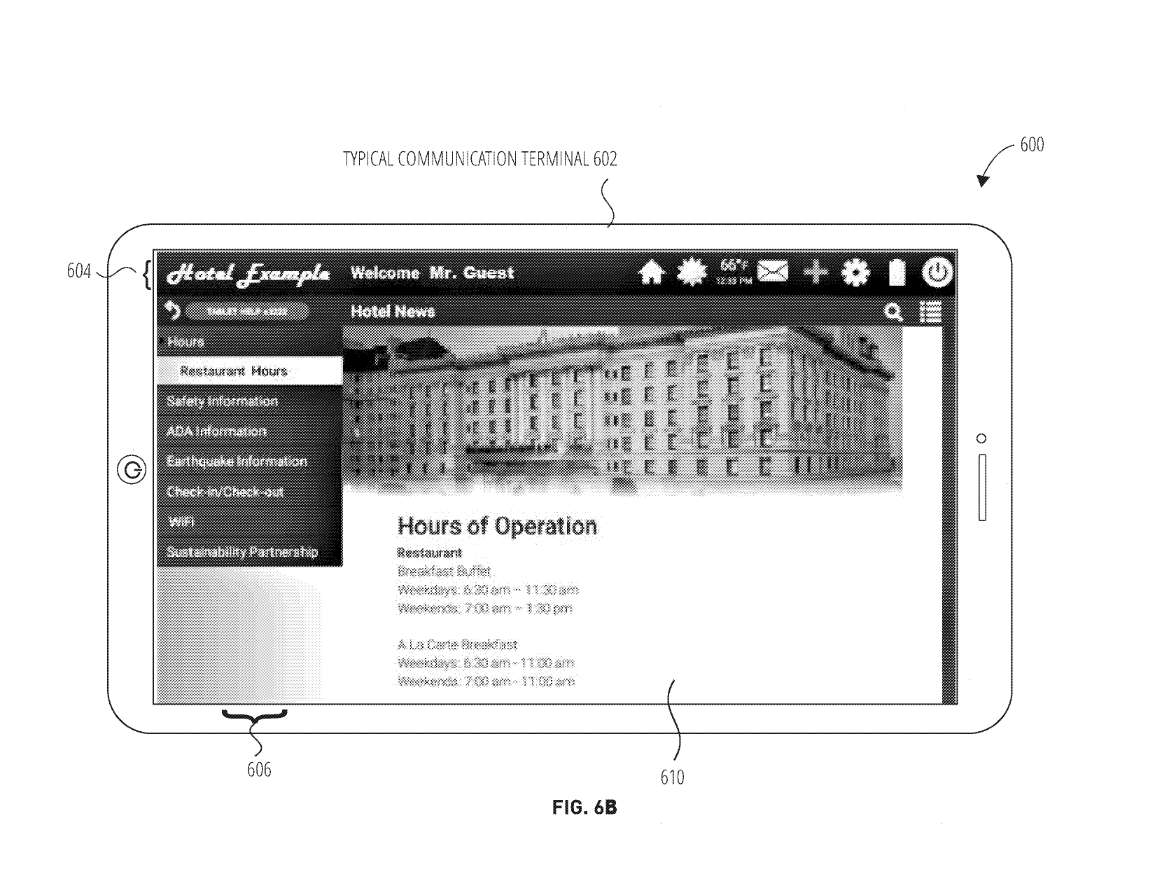

A sample interactive interface is shown in FIG. 6A, described in greater detail below. As a non-limiting example with regard to loyalty tiers, for instance, a default interactive interface, to be provided for non-member guests, may include a branded task bar 604, a left sidebar menu 606, and a center content viewing pane 610. Content tagged for general applicability may be used to construct the default interface. For loyalty rewards program members, however, a template including right sidebar content 616 may be used, and associated content tagged for loyalty tier levels may be used to populate that area, accordingly.

Returning again to FIG. 2, once the interface builder 216 has constructed a customized interactive interface incorporating customized content, the interface may be integrated in this embodiment into the boot code stored in the boot directory 218 block allocated for the associated guest-based group (e.g., loyalty tier level). Upon receiving configuration commands assigning a block to boot from, a communications terminal may upon startup access boot code at the assigned boot block and boot up displaying the appropriate interactive interface and guest-specific content. In the embodiment illustrated, a device 206, in basic member guest room, may receive a set of configuration commands to boot from code stored in the basic member block. Communication terminals may retain the programming loaded at startup for the duration of a guest's stay, regardless of updates made in the content repository 112. In an alternate embodiment, the communications terminal configuration engine 208 or other module may include logic that monitors the boot directory 218 for updates. Upon detecting changes, the communications terminal configuration engine 208 or other module may command communication terminals configured to boot from affected boot block(s) to load the updated interactive interface and customized content.

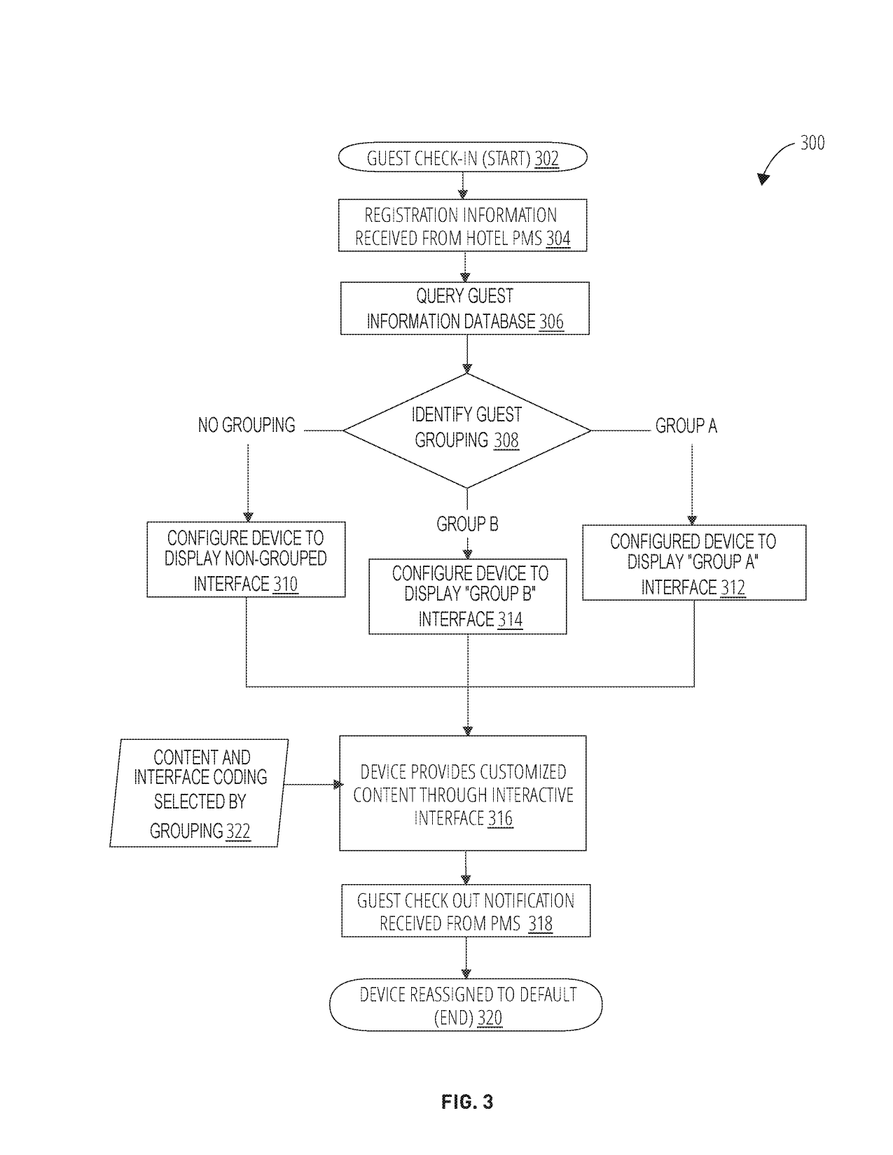

Referring to FIG. 3, an illustrative method 300 according to one embodiment herein comprises the steps followed by the system illustrated in FIG. 1 and/or FIG. 2.

A guest checks into the hotel (start block 302). A record of the guest's registration information may be created. This record may be stored in the PMS 102.

The hotel server 104 receives the guest's registration information (block 304). This may include the guest's name and assigned room number.

The hotel server 104 sends a query to the guest information database 110 (block 306). The hotel server 104 may receive the guest's grouping (e.g., loyalty tier) information in return (e.g., basic loyalty level, premium loyalty level, a particular event, a particular guest group, hereinafter groups “A”, “B”, etc., or else non-member/grouping if no records match the guest's information). In one embodiment, the communication terminals 116 may then receive the guest's grouping information from the guest information database 110 (e.g., “group A”, “group B”, or no grouping), thus determining the guest's grouping information (decision block 308), in order to select the appropriate stored content for display. In an alternative embodiment, the hotel server selects the appropriate content for display and pushes such content to the communication terminals 116, accordingly.

For no grouping (e.g., non-members) (block 310), the communication terminals 116 may be configured to display a default interface and content tagged as applicable for all guests, such hotel services and instructions for emergency situations.

For members of group A (block 312), the communication terminals 116 may be configured to display a default interface, plus a side bar showing information pertinent to group A guests (e.g., rewards that premium level guests may take advantage of, information pertaining to a particular event, such as a wedding, and so on). For example, a coupon for a 20% discount at the hotel gift shop may be included in the customized content for members of group A.

For members of group B (block 314), the communication terminals 116 may be configured to display a default interface, plus a side bar showing information pertinent to group B guests (e.g., rewards that basic level guests are eligible for, information pertaining to a different event, etc.). For example, a coupon for a 10% discount at the hotel gift shop may be included in the customized content for members of group B.

The communication terminals 116 may then configure their display based on the associated group-based content according to the particular guest. For instance, in one embodiment this may be a real-time configuration change pushed to the communication terminals 116 in particular rooms, or in an alternative embodiment, upon startup, the communication terminals 116 in those particular rooms boot from the assigned boot directory block to establish the content (format and/or information) to display. As also noted above, the communication terminals 116 may store all of the different content options, selecting which particular content to display based on receiving the group identification (e.g., loyalty tier, event, etc.), or else in an alternative embodiment, may simply display the content sent to it from the hotel server 104, which is based on the particular group identification for the guest(s) in that corresponding room. That is, in one embodiment, the communication terminals 116 determine which modules of customized content (if any) apply to the guest, based on the received grouping information, while in another embodiment, the intelligence remains within the hotel server 104, and only the current guest-based configuration is stored and executed on the communication terminals 116.

The communication terminals 116 (device 206) may then accordingly provide customized content during the guest's stay (block 316). The content and interactive interface are thus customized by guest grouping (e.g., loyalty tier) (block 322). Throughout the guest's stay, customized content modules may be displayed on the communication terminal in their assigned room, and content may be updated as required. Updates may be based on new information, time-sensitive information, or based on the guest changing their grouping, such as by signing up for a loyalty program or event.

When the guest checks out of the hotel (block 318), their record may be closed out in the PMS. Notification of check-out may be sent to the hotel server 104. The hotel server 104 may reconfigure the communication terminals 116 in the assigned room to return to a default interface/configuration or power off (end block 320).

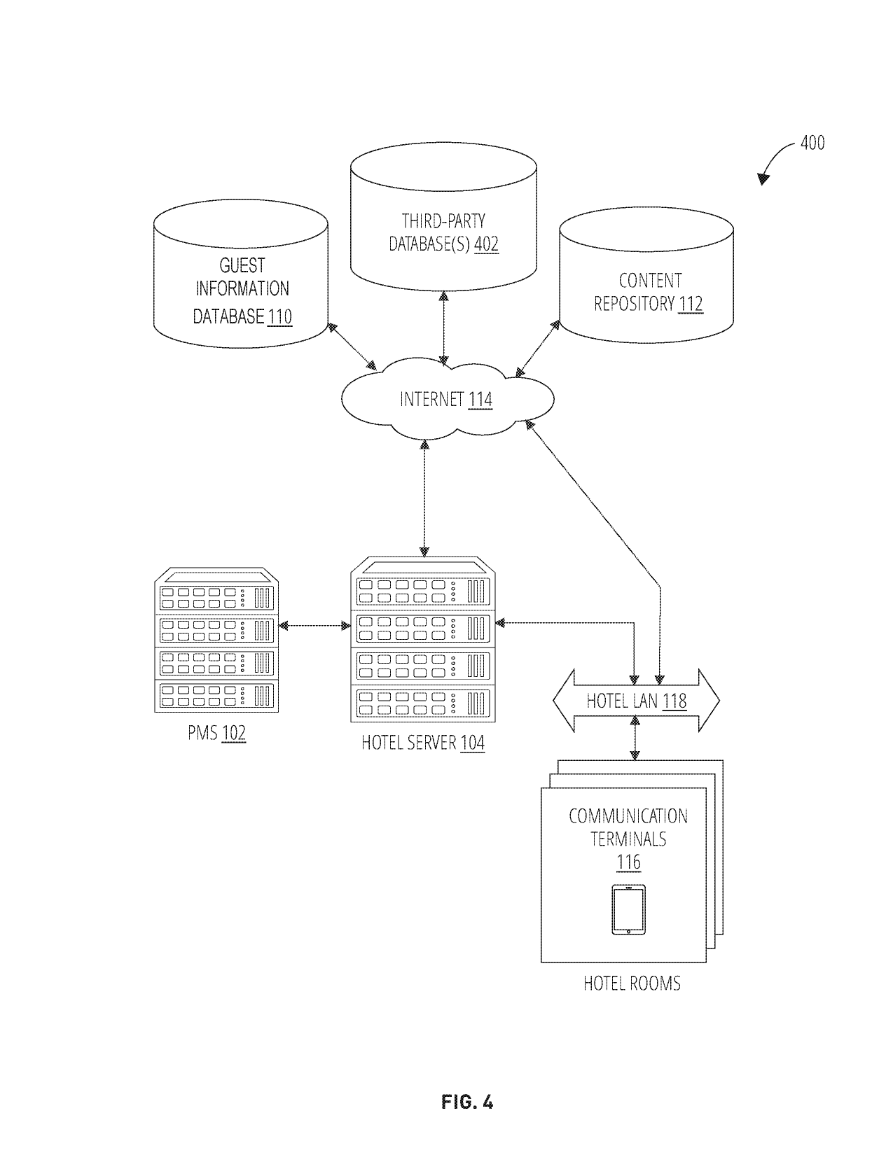

Referring to FIG. 4, the system 400 comprises the addition of third-party database(s) 402 accessed by the hotel server 104 through the Internet 114.

A number of databases may be available online for access by the public or by paying subscribers. Such databases may contain, for example, purchase histories recorded by online retailers or credit card companies. The databases may also record instances of social media check-in or geotagging at various businesses. Where the hotel has licensed access to such database(s), the communication terminals 116 may receive information from these databases (e.g., directly or via the hotel server 104). In some embodiments, a content management system, which manages content in the content repository 112, may also perform these database queries and provide appropriately tagged content to the communication terminals 116. In another embodiment, the hotel server 104 may query the third-party database(s) 402, either before, after, or concurrent with a query of the guest information database 110.

Notably, a guest may be linked to a large number of categories based on information returned by the third-party database query. The configuration engine in the communication terminal or the query engine in the hotel server may incorporate logic allowing categories to be prioritized and limited to a reasonable number. Prioritization logic may also be part of a third-party marketing service or be implicit in the third-party database records accessed.

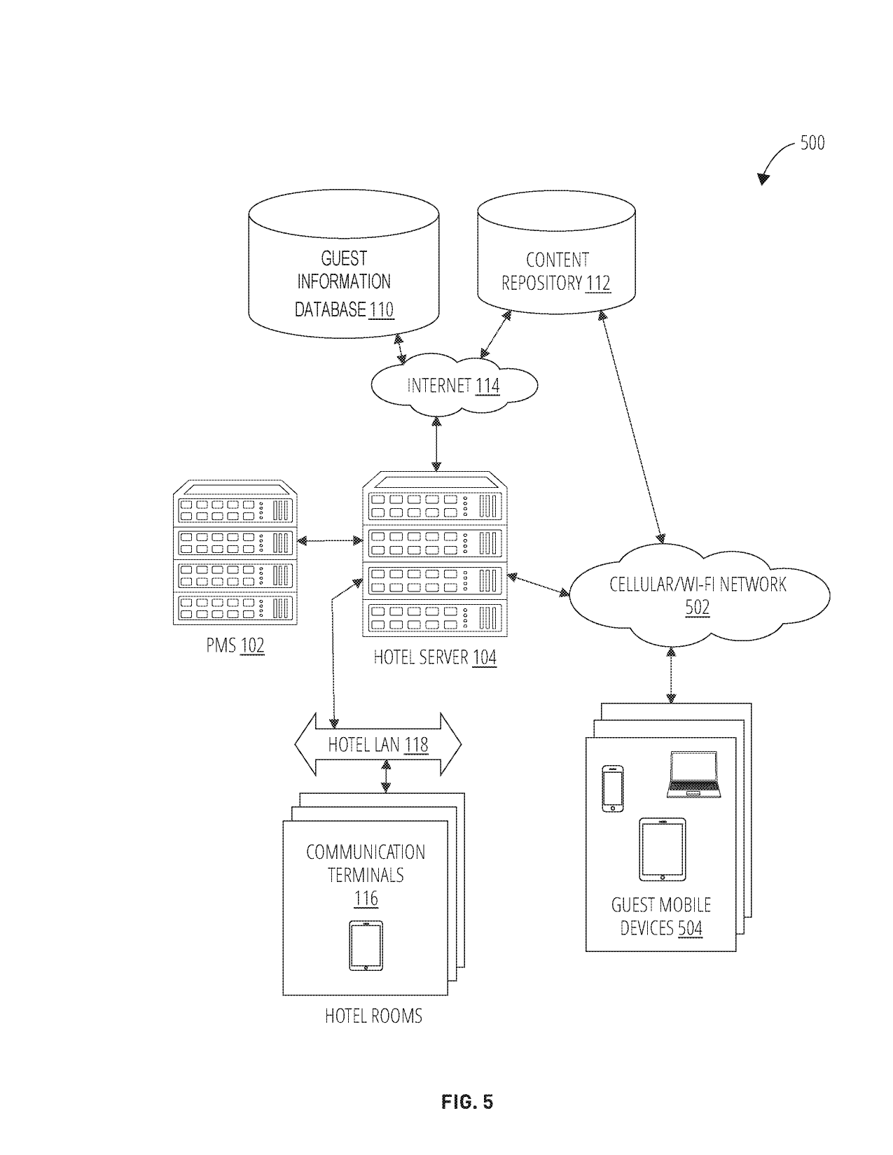

Referring to FIG. 5, a system 500 comprises the addition of guest mobile devices 504, in communication with the hotel server 104 through a cellular/Wi-Fi network 502.

Guest mobile devices 504 may typically comprise cellular phones and tablet computers with communications enabled through either data connections provided by the guest's cellular service provider, or connection to the Internet over a local public or private Wi-Fi network, administered by a business or service at or near the guest's geographic location.

Guests may register their mobile devices as part of check-in at the hotel or, in certain embodiments, when they sign-up with a customer loyalty program. An invitation to download a mobile application may be sent to these mobile devices, or the communication terminals 116 in the guest's assigned room may display instructions for locating and downloading a mobile application over the Internet. Once installed, the mobile application may allow the guest mobile devices 504 to mirror the communication terminals 116 provided by the hotel, such as through an associated application (app).

Referring to FIG. 6A, the sample interactive interface 600 shows elements that may be included in the interactive interface generated for a typical communication terminal 602 located in the room of a guest who is a member of a particular grouping, such as a member of a loyalty rewards program.

A template used by the interface builder 216 module in the communication terminals 116 may collect content for display or linked access via a number of screen modules. For example, the top of the interface may comprise a branded task bar 604. Beneath that, there may be left sidebar menu 606, center content viewing pane 610, and right sidebar content 616 areas.

Customized content may be allocated to one or more of these screen areas. For example, general hotel information may be linked from the left sidebar menu 606 and displayed in the center content viewing pane 610. This information may include operating hours for hotel restaurants and services, among other things.

As an example, an offer at a local store 612 may be shown as part of a loyalty rewards the guest is eligible for. The offer may appear in the right sidebar content 616 and remain visible as the guest navigates other customized content in the center content viewing pane 610. Additionally, the sidebar content may be linked to display a larger format of the content in the center content viewing pane 610 when clicked in the sidebar. Other examples of customer loyalty program benefits may include discounted admission fees to local sporting events, VIP room access at local clubs, or a free drink at the hotel bar, and so on.

As another example, a particular local attraction 614 may be displayed if the guest's personal online data indicates an interest. Again, the content may appear in the right sidebar content 616 and remain visible as the guest navigates other customized content in the center content viewing pane 610. Additionally, the sidebar content may be linked to display a larger format of the content in the center content viewing pane 610 when clicked in the sidebar. For example, if access to a public third-party database provides the information that the guest has previously checked-in on social media while on a dinner cruise, an advertisement for a local business that also runs dinner cruises may be displayed. If a recent golf club purchase is indicated, advertisement for the hotel's golf course may be featured.

This display may be the end result of the method and system disclosed herein. Such a display represents a cost-effective and scalable solution to the problem of providing targeted, on demand content directly to a hotel guest's assigned room. The content displayed may be optimized based on the guest's interests, groups, events, and standing in a customer loyalty program, in order to maximize guest use of and response to the content provided.

As an alternative, FIG. 6B illustrates an example of the sample interactive interface 600 that shows how elements included in the interactive interface generated for a communication terminal 602 may differ from FIG. 6A if located in the room of a guest who is not a member of any particular grouping, such as not being a member of a loyalty rewards program. Though in one embodiment the template may be same and only the content differs, as shown in FIG. 6B, the template itself may also change, such as removing the entire right sidebar content 616 area. Other variants of changes may be made, and the ones shown and discussed herein are merely examples for illustration.

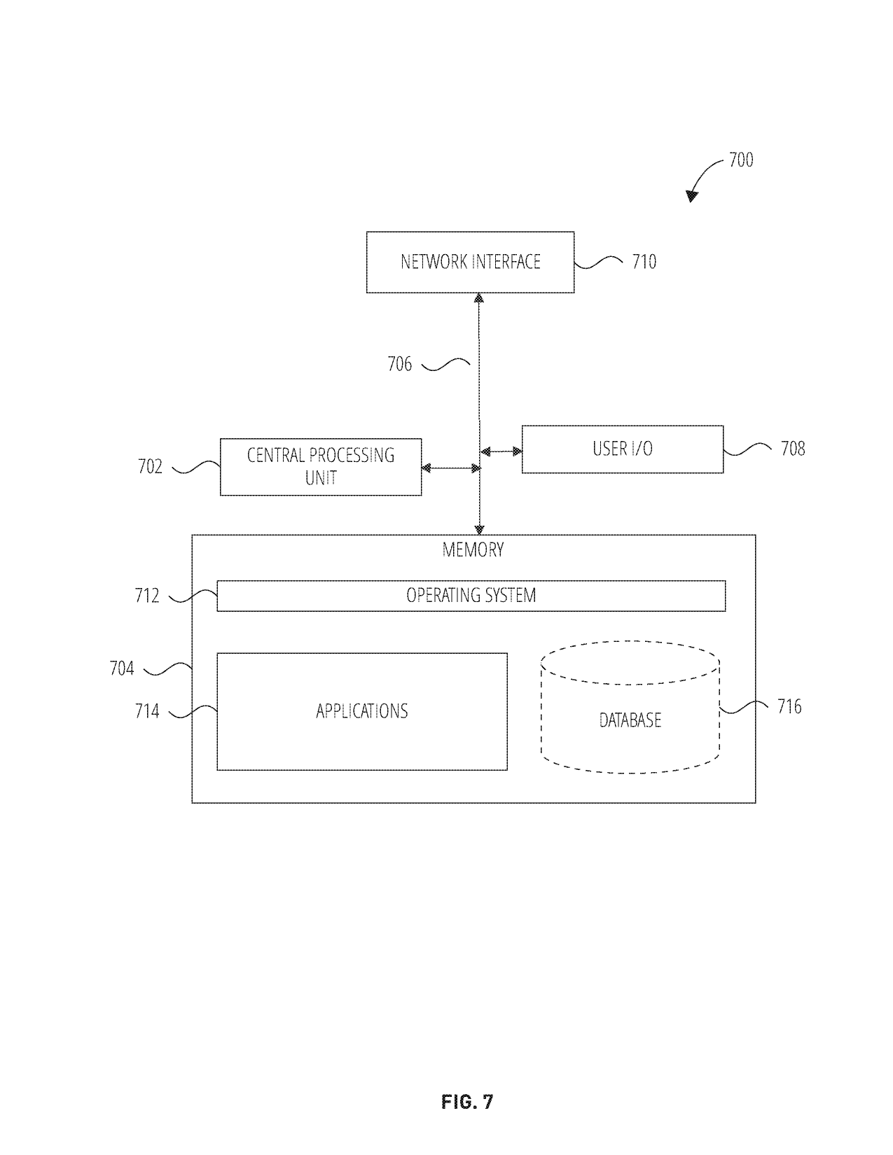

Referring to FIG. 7, an embodiment of a computer system 700 useful in implementing the methods disclosed herein comprises a central processing unit 702, memory 704, a bus 706, user I/O 708, a network interface 710, an operating system 712, applications 714, and a database 716.

In various embodiments, system 700 may include a desktop PC, server, workstation, mobile phone, laptop, tablet, set-top box, appliance, or other computing device that is capable of performing operations such as those described herein. In some embodiments, system 700 may include more or fewer components than those shown in FIG. 7. However, it is not necessary that all of these generally conventional components be shown in order to disclose an illustrative embodiment. Collectively, the various tangible components or a subset of the tangible components may be referred to herein as "logic" configured or adapted in a particular way, for example as logic configured or adapted with particular software or firmware.

In various embodiments, system 700 may comprise one or more physical and/or logical devices that collectively provide the functionalities described herein. In some embodiments, system 700 may comprise one or more replicated and/or distributed physical or logical devices.

In some embodiments, system 700 may comprise one or more computing resources provisioned from a cloud computing provider, as will be understood by those skilled in the art.

System 700 includes a bus 706 interconnecting several components including a network interface 710, user I/O 708, a central processing unit 702, and a memory 704.

Memory 704 generally comprises a random access memory ("RAM") and permanent non-transitory mass storage device, such as a hard disk drive or solid-state drive. Memory 704 stores an operating system 712, and may also store applications 714 used for both general operation and for implementing the methods disclosed herein. Memory 704 may also include a database 716. In some embodiments, system 700 may communicate with database 716 via network interface 710, a storage area network ("SAN"), a high-speed serial bus, and/or via the other suitable communication technology.

In some embodiments, database 716 may comprise one or more storage resources provisioned from a cloud storage provider, as will be understood by those skilled in the art.

User I/O 708 may comprise one or more components allowing human interaction with the computing system 700, such as a monitor, a touch screen display, a mouse, a keyboard, a stylus, or other, similar devices.

Terms used herein should be accorded their ordinary meaning in the relevant arts, or the meaning indicated by their use in context, but if an express definition is provided, that meaning controls.

"Circuitry" in this context refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

"Firmware" in this context refers to software logic embodied as processor-executable instructions stored in read-only memories or media.

"Hardware" in this context refers to logic embodied as analog or digital circuitry.

"Logic" in this context refers to machine memory circuits, non transitory machine-readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

"Software" in this context refers to logic implemented as processor-executable instructions in a machine memory (e.g. read/write volatile or nonvolatile memory or media).

Herein, references to "one embodiment" or "an embodiment" do not necessarily refer to the same embodiment, although they may. Unless the context clearly requires otherwise, throughout the description and the claims, the words "comprise," "comprising," and the like are to be construed in an inclusive sense as opposed to an exclusive or exhaustive sense; that is to say, in the sense of "including, but not limited to." Words using the singular or plural number also include the plural or singular number respectively, unless expressly limited to a single one or multiple ones. Additionally, the words "herein," "above," "below" and words of similar import, when used in this application, refer to this application as a whole and not to any particular portions of this application. When the claims use the word "or" in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting said operation or function. For example, an association operation may be carried out by an "associator" or "correlator". Likewise, switching may be carried out by a "switch", selection by a "selector", and so on.

Additional and/or alternative embodiments may also be contemplated in accordance with the present disclosure and the techniques described herein. For instance, in one embodiment, the groupings may be based on a guest’s language preference (e.g., groups for English, French, Chinese, Japanese, etc.), and as such, the information (or perhaps even the format) of the customized interface may be established based on the appropriate language group.

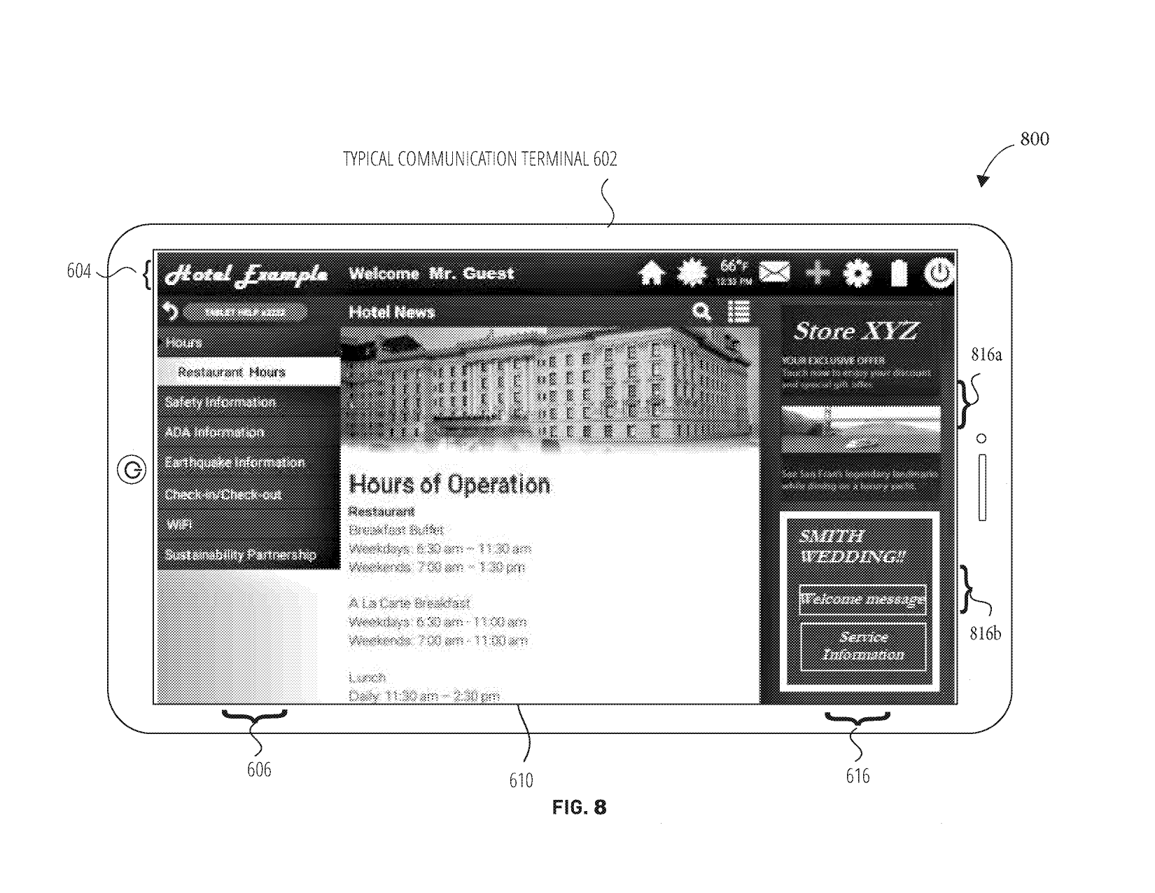

Also, in one embodiment, a guest may be associated with a plurality of groups at the same time. For example, a guest may be a member of a loyalty program (a first group), and may be staying at the hotel for a friend’s wedding for the weekend (a second group). Another guest may be a member of the same loyalty program, but may be attending a work conference at the hotel or at a convention center in the same city as the hotel (a third group). FIG. 8 illustrates an example interactive interface 800 similar to FIGS. 6A-6B, showing elements that may be included in the interactive interface generated for a typical communication terminal 602 located in the room of a guest who is a member of a plurality of grouping, such as a member of a loyalty rewards program and an attendee of an on-site wedding. For example, the top of the interface may still comprise a branded task bar 604, a left sidebar menu 606 general hotel information, and center content viewing pane 610 to display the details of the current selection. However, in this embodiment, right sidebar content 616 now has a plurality of sub-content areas 816a and 816b, with the first content in 816a corresponding to the first grouping (e.g., loyalty rewards program based information) and the second content in 816b corresponding to the second grouping (e.g., wedding information).

Also, groupings may be combined, such as where a single interactive interface with customized content corresponds to each combination of groups. For instance, a premium loyalty tier (first group) for an English speaking guest (second group) would result in one interface, while a premium loyalty tier (first group) for a French speaking guest (third group) would result in a different interface.

In another embodiment, such multi-grouping in this manner may be based on groups and “sub-groups”. For instance, groups may comprise a super-set of categorization, such as whether a guest is or is not a participant in a member reward program, while sub-groups are a more specific categorization within a group, such as a particular loyalty tier of the member reward program. Many group/sub-group pairings may be conceived, such as program members and languages, schools and classes, companies and departments, events and sections, and so on.

In still further embodiments, groupings may be based on many different configurable options, such as floors of a hotel, room types (e.g., rooms, suites, penthouses, particular views, particular buildings of a multi-building hotel, etc.), and so on. Other examples of use cases for groupings, sub-groupings, formatting, content, and so on may be established according to the techniques herein, and those specifically mentioned herein are not meant to be limiting to the scope of the present disclosure.

In closing, an illustrative system according to one or more embodiments of the present disclosure may comprise: a server; and a plurality of communication terminals in communication with the server, each of the communication terminals having a graphical user interface (GUI) and being associated with a respective room of a plurality of hotel rooms of a hotel; wherein the server is configured to receive registration information when a guest checks into the hotel, the registration information including an identification of the guest and a particular assigned room of the plurality of hotel rooms; wherein the server is configured to identify a particular communication terminal of the plurality of communication terminals that is associated with the particular assigned room; wherein one of either the server or the particular communication terminal is configured to query a guest information database using the identification of the guest to determine a particular grouping associated with the guest; wherein one of either the server or the particular communication terminal is configured to store an interactive interface comprising customized content specific to the particular grouping associated with the guest; and wherein the particular communication terminal is configured to present the interactive interface comprising customized content specific to the particular grouping associated with the guest on a corresponding GUI of the particular communication terminal.

In one embodiment, the particular grouping associated with the guest is selected from a plurality of different loyalty tier groupings associated with the hotel.

In one embodiment, the customized content specific to the plurality of different loyalty tier groupings comprises respective reward offers for each of the plurality of different loyalty tier groupings.

In one embodiment, querying the guest information database using the identification of the guest determines a plurality of groupings associated with the guest; wherein one of either the server or the particular communication terminal is configured to store an interactive interface incorporating customized content specific to each of the plurality of groupings associated with the guest; and wherein the particular communication terminal is configured to present the interactive interface incorporating customized content specific to each of the plurality of groupings associated with the guest on the corresponding GUI of the particular communication terminal.

In one embodiment, the customized content comprises one or both of formatting and information.

In one embodiment, querying the guest information database using the identification of the guest determines that there are no groupings associated with the guest; wherein one of either the server or the particular communication terminal is configured to store an interactive interface comprising general content for guests with no associated groupings; and wherein the particular communication terminal is configured to present the interactive interface comprising general content on the corresponding GUI of the particular communication terminal.

In one embodiment, the particular grouping associated with the guest is selected from a plurality of different language groupings, and wherein the interactive interface comprising customized content specific to the particular grouping associated with the guest comprises a corresponding base language.

In one embodiment, the server is configured to identify a mobile device associated with the guest, and to configure a mobile application of the mobile device to mirror the particular communication terminal while the guest is staying at the hotel.

In one embodiment, the particular grouping associated with the guest further comprises a particular sub-grouping associated with the guest, and wherein the customized content comprises formatting based on the particular grouping associated with the guest and information based on the particular sub-grouping associated with the guest.

In one embodiment, the particular grouping associated with the guest is based on whether the guest is a participant in a member rewards program associated with the hotel, and wherein the particular sub-grouping associated with the guest is selected from a plurality of different loyalty tier groupings associated with the member rewards program.

In one embodiment, the particular communication terminal is configured to present the interactive interface comprising customized content specific to the particular grouping associated with the guest based on one of either a) referencing a particular boot block within a memory corresponding to the interactive interface comprising customized content specific to the particular grouping associated with the guest, or b) real-time downloading of the interactive interface comprising customized content specific to the particular grouping associated with the guest.

In one embodiment, the particular grouping associated with the guest is selected from a plurality of different groupings associated with one or more of the hotel, a parent company of the hotel, and one or more third-party entities, and wherein the guest information database queried comprises a hotel database, a parent company database, and a third-party database, respectively.

In one embodiment, the customized content is populated from one or more of the hotel, a parent company of the hotel, and one or more third-party entities.

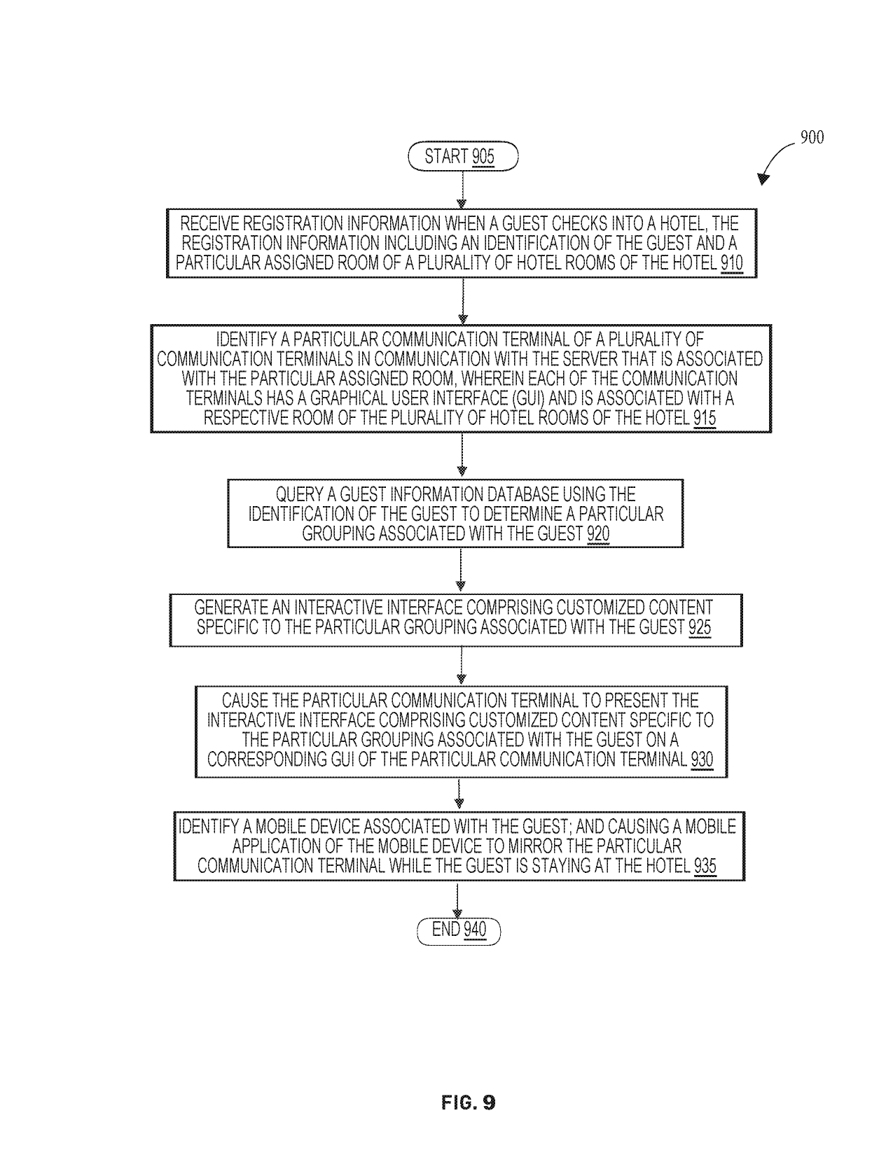

Additionally, FIG. 9 illustrates an example simplified procedure for managing room-based hotel communication terminal content based on guest information in accordance with one or more embodiments described herein, particularly from the perspective of a system of a hotel server 104. For example, a non-generic, specifically configured device (e.g., hotel server 104) may perform procedure 900 by executing stored instructions. The procedure 900 may start at step 905, and continues to step 910, where, as described in greater detail above, the server receives registration information when a guest checks into a hotel, the registration information including an identification of the guest and a particular assigned room of a plurality of hotel rooms of the hotel. In step 915, the server identifies a particular communication terminal of a plurality of communication terminals in communication with the server that is associated with the particular assigned room, wherein each of the communication terminals has a graphical user interface (GUI) and is associated with a respective room of the plurality of hotel rooms of the hotel.

Then, in one embodiment, in step 920 the server queries a guest information database using the identification of the guest to determine a particular grouping associated with the guest, and in step 925 generates an interactive interface comprising customized content specific to the particular grouping associated with the guest. In an alternative embodiment, the server informs the particular communication terminal of the identification of the guest, and the terminal may perform these steps, accordingly. In still another alternative embodiment, the server performs step 920, then informs the particular communication terminal of the particular grouping, such that the terminal may perform step 925 based on the grouping.

In step 930, the server causes the particular communication terminal to present the interactive interface comprising customized content specific to the particular grouping associated with the guest on a corresponding GUI of the particular communication terminal.

Note that other steps may be included within procedure 900, such as generating an interactive interface incorporating customized content specific to each of a plurality of groupings associated with the guest, and causing the particular communication terminal to present the interactive interface incorporating customized content specific to each of the plurality of groupings associated with the guest on the corresponding GUI of the particular communication terminal.

Optionally, in step 935, the server may also identify a mobile device associated with the guest as described above, and may cause a mobile application of the mobile device to mirror the particular communication terminal while the guest is staying at the hotel.

The illustrative simplified procedure 900 may then end in step 940, notably with the option to update the content, or to return the terminal to a default or other action upon checkout of the guest, accordingly.

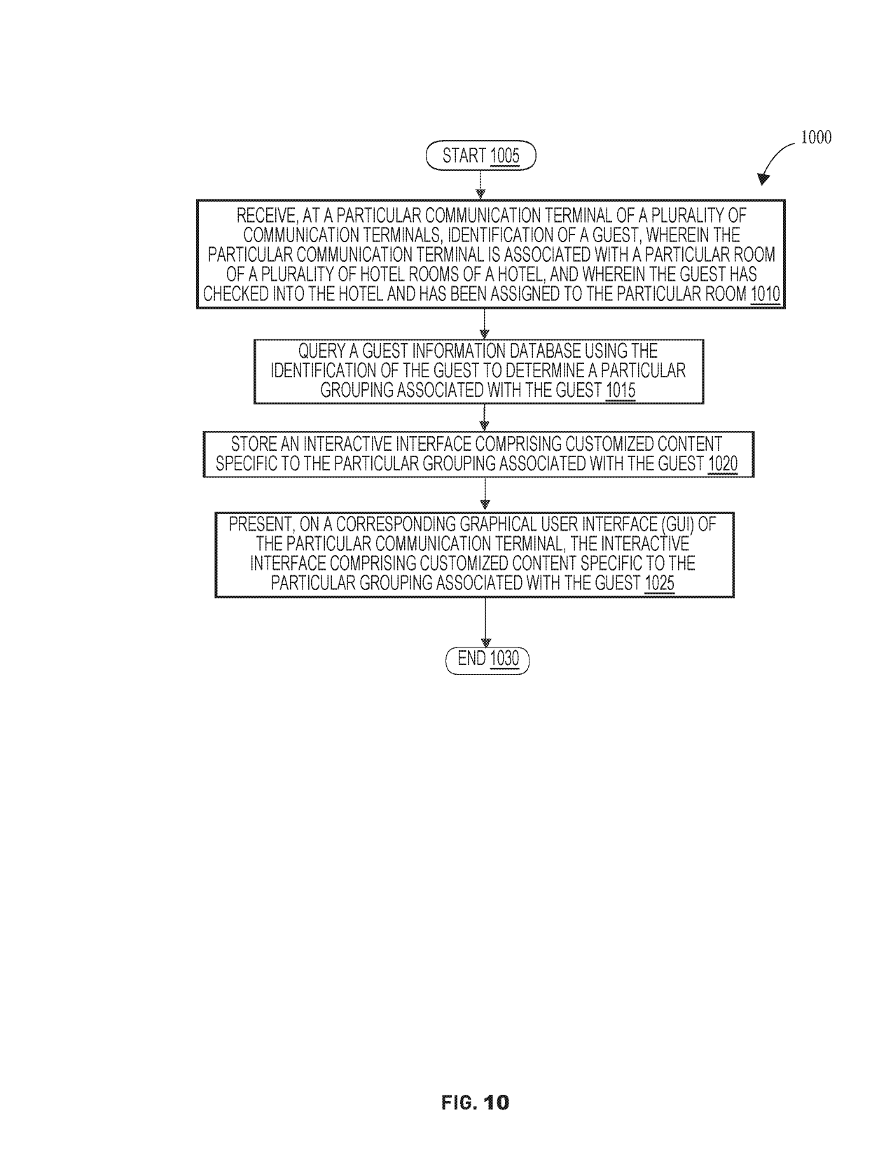

Moreover, FIG. 10 illustrates another example simplified procedure for managing room-based hotel communication terminal content based on guest information in accordance with one or more embodiments described herein, particularly from the perspective of a communication terminal 116. For example, a non-generic, specifically configured device (e.g., communication terminal 116) may perform procedure 1000 by executing stored instructions. The procedure 1000 may start at step 1005, and continues to step 1010, where, as described in greater detail above, a particular communication terminal of a plurality of communication terminals receives identification of a guest, wherein the particular communication terminal is associated with a particular room of a plurality of hotel rooms of a hotel, and wherein the guest has checked into the hotel and has been assigned to the particular room.

As such, in step 1015, the particular communication terminal may query a guest information database using the identification of the guest to determine a particular grouping associated with the guest, and in step 1020 stores an interactive interface comprising customized content specific to the particular grouping associated with the guest. As noted above, one or both of steps 1015-1020 may be performed by the server, and the illustrative procedure 1000 is merely one example embodiment.

In step 1025, the particular communication terminal presents the interactive interface comprising customized content specific to the particular grouping associated with the guest on a corresponding graphical user interface (GUI), and the procedure ends in step 1030 (e.g., until content is updated or until the guest checks out, as noted above).

It should be noted that while certain steps within procedures 900-1000 may be optional as described above, the steps shown in FIGS. 9-10 are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures 900-1000 are described separately, certain steps from each procedure may be incorporated into each other procedure, and the procedures are not meant to be mutually exclusive.

Advantageously, the techniques described herein thus provide for managing room-based hotel communication terminal content based on guest information. Hotels, and particularly those with a loyalty rewards program and associated partner businesses, can use the techniques herein to provide real-time, on-demand, customized content to their guests, directly to their hotel rooms, in order to optimize customer response. The complete solution is economically viable and is scalable to serve hotel businesses of all sizes, from hotels that are independently owned and run to international hotel chains.

While there have been shown and described illustrative embodiments, it is to be understood that various other adaptations and modifications may be made within the scope of the embodiments herein. For example, though the disclosure was often described with respect to hotels, those skilled in the art should understand that this was done only for illustrative purpose and without limitations, and the techniques herein may be used with any temporary accommodation where group-based customized content is to be managed, such as for house rentals, apartment rentals, condo rentals, room rentals, office rentals, and so on, that may partake in such things as member rewards, loyalty tiering, or other group-based activities/events. In addition, though the disclosure was often described specifically with respect to customer loyalty tiering examples, those skilled in the art should understand that this was also only for illustrative purpose and without limitations, and the techniques herein may be used for any groupings of guests, as mentioned above (e.g., events, groups, languages, demographics, etc.). Furthermore, while the embodiments may have been demonstrated with respect to certain communication environments, physical environments, or device form factors, other configurations may be conceived by those skilled in the art that would remain within the contemplated subject matter of the description above.

The foregoing description has been directed to specific embodiments. It will be apparent, however, that other variations and modifications may be made to the described embodiments, with the attainment of some or all of their advantages. For instance, it is expressly contemplated that certain components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true intent and scope of the embodiments herein.

What is claimed is:

1. A system, comprising:
a plurality of communication terminals, each of the plurality of communication terminals associated with a corresponding guest room of a hotel and configured to present an interactive interface to a guest located in the corresponding guest room; and
one or more servers communicatively coupled to the plurality of communication terminals, the one or more servers configured to:
receive registration information indicating that a guest has checked into the hotel, the registration information and identifying a particular guest room of the hotel assigned to the guest;
identify, based on the registration information, a particular communication terminal associated with the particular guest room assigned to the guest;
determine, based on guest information stored in a guest information database, a particular guest grouping associated with the guest;
select, based on the particular guest grouping, a specific interface template for generating a customized interactive interface for the guest;
generate, using the specific interface template, the customized interactive interface for the guest that is customized for the particular guest grouping; and
configure the particular communication terminal to present the customized interactive interface for the guest by causing the particular communication terminal to obtain the customized interactive interface either by (i) referencing a boot block within a memory of the particular communication terminal corresponding to the customized interactive interface, or (ii) real-time downloading the customized interactive interface from the one or more servers.

2. The system of claim 1, wherein the customized interactive interface contains content specific to a plurality of different loyalty tier groupings comprising respective reward offers for each of the plurality of different loyalty tier groupings.

3. The system of claim 1, wherein the customized interactive interface comprises one or both of formatting and information.

4. The system of claim 1, wherein there are no groupings associated with the guest, and wherein the specific interface template comprises a general interface comprising general content for guests with no associated groupings.

5. The system of claim 1, wherein the specific interface template comprises a corresponding base language.

6. The system of claim 1, wherein the one or more servers are further configured to identify a mobile device associated with the guest, and to configure a mobile application of the mobile device to mirror the particular communication terminal while the guest is staying at the hotel.

7. The system of claim 1, wherein the particular guest grouping comprises a particular sub-grouping associated with the guest, and wherein the specific interface template contains customized content comprising formatting based on the particular guest grouping and information based on the particular sub-grouping associated with the guest.

8. The system of claim 7, wherein the particular guest grouping is based on whether the guest is a participant in a member rewards program associated with the hotel, and wherein the particular sub-grouping associated with the guest is selected from a plurality of different loyalty tier groupings associated with the member rewards program.

9. The system of claim 1, wherein the particular guest grouping is selected from a plurality of different groupings associated with one or more of the hotel, a parent company of the hotel, and one or more third-party entities, and wherein the guest information database comprises a hotel database, a parent company database, and a third-party database, respectively.

10. The system of claim 1, wherein the customized interactive interface is populated from one or more of the hotel, a parent company of the hotel, and one or more third-party entities.

11. A method for performance by one or more servers communicatively coupled to a plurality of communication terminals, each of the plurality of communication terminals associated with a corresponding guest room of a hotel and configured to present an interactive interface to a guest located in the corresponding guest room, the method comprising:
receiving registration information indicating that a guest has checked into the hotel, the registration information and identifying a particular guest room of the hotel assigned to the guest;
identifying, based on the registration information, a particular communication terminal associated with the particular guest room assigned to the guest;
determining, based on guest information stored in a guest information database, a particular guest grouping associated with the guest;
selecting, based on the particular guest grouping, a specific interface template for generating a customized interactive interface for the guest;
generating, using the specific interface template, the customized interactive interface for the guest that is customized for the particular guest grouping; and
configuring the particular communication terminal to present the customized interactive interface for the guest by causing the particular communication terminal to obtain the customized interactive interface either by (i) referencing a boot block within a memory of the particular communication terminal corresponding to the customized interactive interface, or (ii) real-time downloading the customized interactive interface from the one or more servers.

12. The method of claim 11, wherein the customized interactive interface contains content specific to a plurality of different loyalty tier groupings comprising respective reward offers for each of the plurality of different loyalty tier groupings.

13. The method of claim 11, wherein the customized interactive interface comprises one or both of formatting and information.

14. The method of claim 11, wherein there are no groupings associated with the guest, and wherein the specific interface template comprises a general interface comprising general content for guests with no associated groupings.

15. The method of claim 11, wherein the specific interface template comprises a corresponding base language.

16. The method of claim 11, further comprising:
identifying a mobile device associated with the guest; and
configuring a mobile application of the mobile device to mirror the particular communication terminal while the guest is staying at the hotel.

17. The method of claim 11, wherein the particular guest grouping comprises a particular sub-grouping associated with the guest, and wherein the specific interface template contains customized content comprising formatting based on the particular guest grouping and information based on the particular sub-grouping associated with the guest.

18. The method of claim 17, wherein the particular guest grouping is based on whether the guest is a participant in a member rewards program associated with the hotel, and wherein the particular sub-grouping associated with the guest is selected from a plurality of different loyalty tier groupings associated with the member rewards program.

19. The method of claim 11, wherein the particular guest grouping is selected from a plurality of different groupings associated with one or more of the hotel, a parent company of the hotel, and one or more third-party entities, and wherein the guest information database comprises a hotel database, a parent company database, and a third-party database, respectively.

20. The method of claim 11, wherein the customized interactive interface is populated from one or more of the hotel, a parent company of the hotel, and one or more third-party entities.
